(19) United States
(12) Patent Application Publication
(10) Pub. No.: US 2013/0265636 A1
(43) Pub. Date: Oct. 10, 2013

(54) TUNABLE OPTICAL PARAMETRIC AMPLIFIER

(71) Applicant: Alexey Gusev, Sarasota, FL (US)

(72) Inventor: Alexey Gusev, Sarasota, FL (US)

(21) Appl. No.: 13/441,594

(22) Filed: Apr. 6, 2012

(51) Int. Cl. G02F 1/39

(52) U.S. Cl. 359/342

(57) ABSTRACT

An apparatus, system, and method are disclosed. One method comprises energizing a photonic crystal fiber to generate a seed beam of electromagnetic radiation as an output of the photonic crystal fiber, transmitting the seed beam to a non-linear crystal, and generating an amplified beam of electromagnetic radiation based on the seed beam.

### BACKGROUND

Tunable optical parametric amplifiers currently require very high peak powers and therefore require amplified femtosecond lasers, which are significantly more expensive than non-amplified femtosecond oscillators.

Optical Parametric Amplifiers (OPA) are a useful tool that allows continuous tuning (modification) of wavelength of a laser output, which would otherwise be limited to the fundamental wavelength and its harmonics. However, one limitation of the current white light seed based OPA designs is the special laser pulse requirements for the supercontinuum seed generation. These requirements include the pulse duration and the pulse energy, wherein:

1. The pulse duration should generally not exceed 500 fs (femtoseconds); and

2. The pulse energy should generally be above 1 uJ.

Such pulses are currently only available from amplified femtosecond laser systems. These laser systems contain a femtosecond oscillator producing pulses with nJ (nanojoule) energies (typically up to 20 nJ) and a femtosecond amplifier that amplifies the femtosecond pulses from the oscillator to mJ (millijoule) energy levels. The femtosecond amplifier itself is quite expensive and typically costs ˜$150,000, which is almost twice the cost of a femtosecond oscillator alone (˜$80,000).

A femtosecond source of coherent tunable blue, green, or yellow light would have a substantial number of potential applications. A means of converting readily available red or infrared non-amplified femtosecond oscillator laser radiation into blue, green or yellow light would also be advantageous. However, there are presently no tunable femtosecond laser oscillators operating at these wavelengths.

It would be extremely advantageous to have a white light based OPA that does not require a femtosecond amplifier and can work with an oscillator laser alone.

### SUMMARY

The present disclosure relates to devices that convert light from one wavelength to another and in particular to an optical parametric amplifier where a photonic crystal fiber is used to generate the broadband optical seed pulse.

In an aspect, a system can comprise a photonic crystal fiber receiving a pump pulse of electromagnetic radiation and generating a seed pulse of electromagnetic radiation and a non-linear crystal receiving the seed pulse and the pump pulse and generating an amplified pulse of electromagnetic radiation based on parametric amplification of the seed pulse.

In another aspect, a method can comprise receiving a pump pulse of electromagnetic radiation at a photonic crystal fiber, generating a seed pulse of electromagnetic radiation as an output of the photonic crystal fiber, receiving the seed pulse and the pump pulse at a non-linear crystal, and generating an amplified pulse of electromagnetic radiation based on parametric amplification of the seed pulse.

In another aspect, a method can comprise energizing a photonic crystal fiber to generate a seed beam of electromagnetic radiation as an output of the photonic crystal fiber, transmitting the seed beam to a non-linear crystal, and generating an amplified beam of electromagnetic radiation based on the seed beam.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary system;

FIG. 2 is an exemplary seed generation stage of the system of FIG. 1;

FIG. 3 is an exemplary output of the seed generation stage of FIG. 2;

FIG. 4A is an exemplary method;

FIG. 4B is an exemplary method;

FIG. 4C is an exemplary method; and

FIG. 5 is an exemplary computing device.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

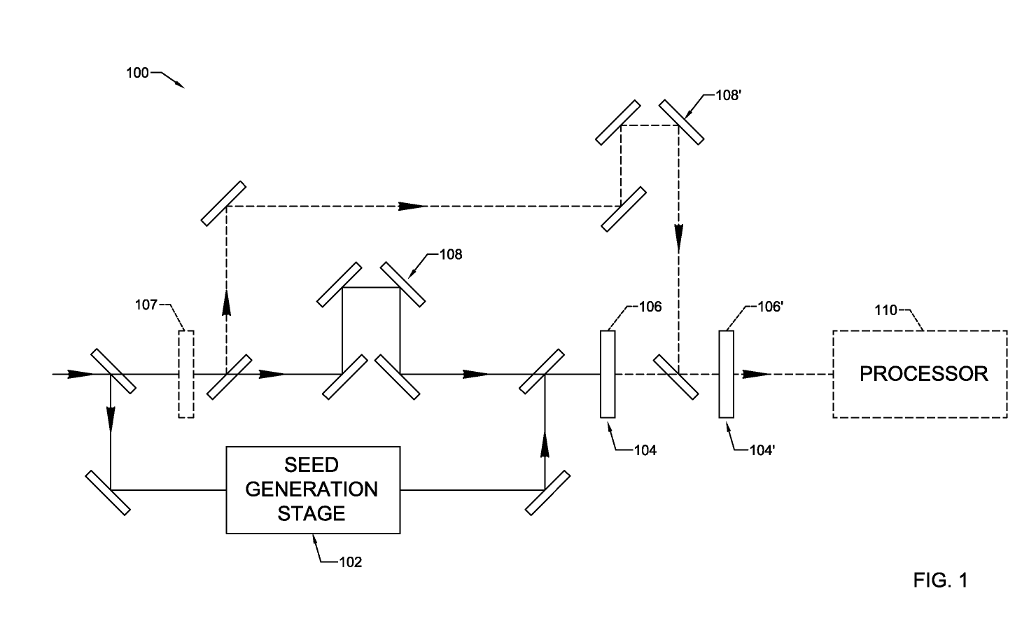

FIG. 1 illustrates an exemplary system 100. In an aspect, the system 100 can comprise a seed generation stage 102 and one or more amplification stages 104, 104′. As an example, the seed generation stage 100 can comprise one or more components to facilitate the generation of a seed signal or seed pulse (e.g., broadband supercontinuum (white light) pulse).

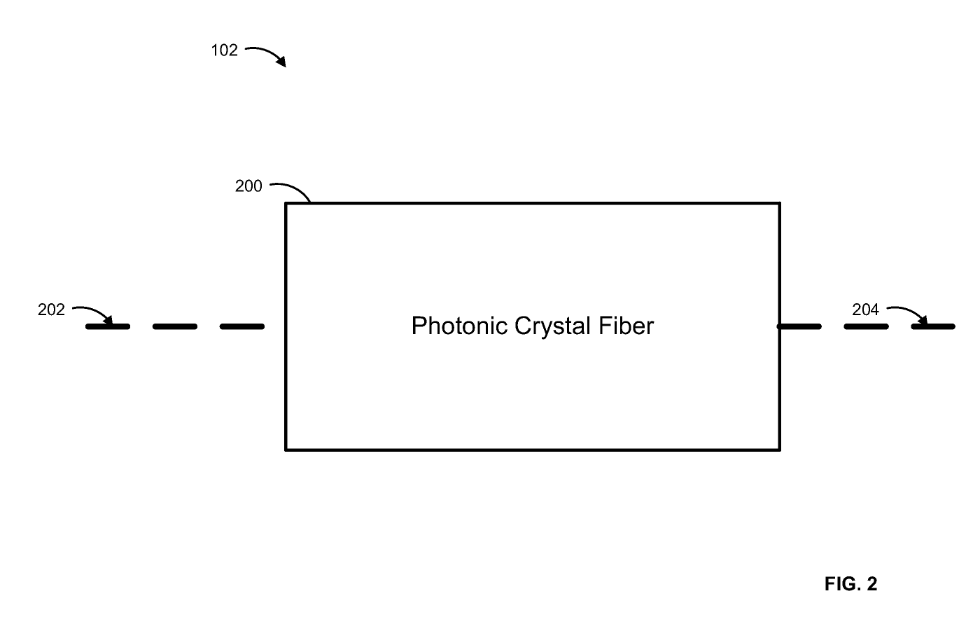

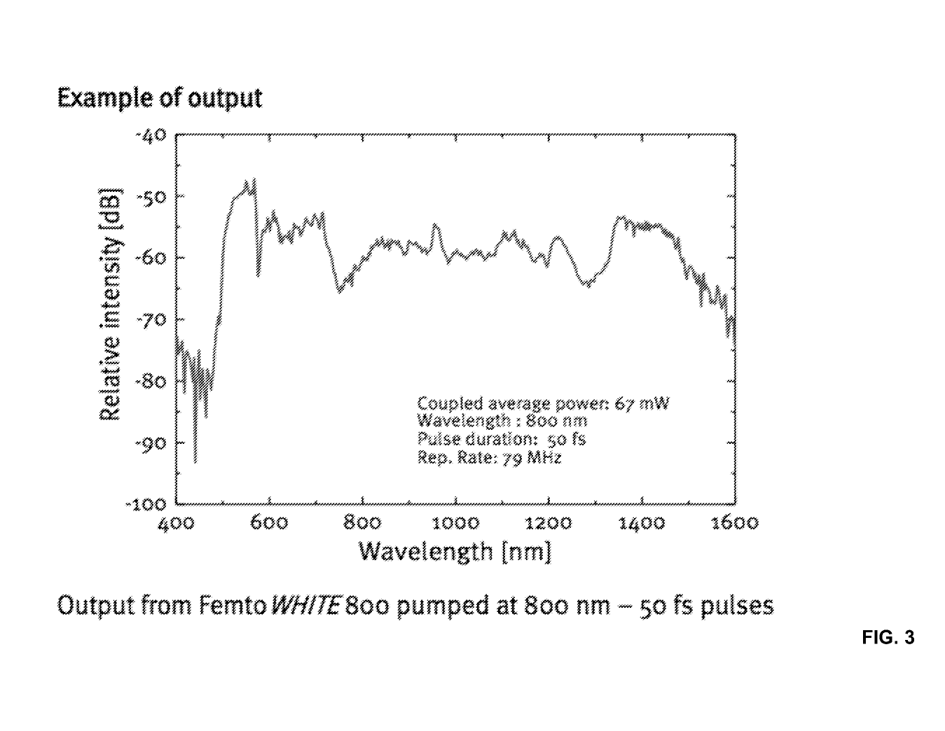

As shown in FIG. 2, for example, the seed generation stage 100 can comprise a photonic crystal fiber (PCF) 200. In an aspect, a beam of electromagnetic radiation 202 (e.g., a pump signal or pump pulse) irradiates the PCF 200 to generate an output radiation 204 (e.g., seed signal or seed pulse). As an example, a seed pulse can be generated by energizing the PCF 200 using a pulsed pump radiation having a pre-determined pulse duration. As an example, the PCF 200 can be a supercontinuum device such as Femtowhite 800 produced by NKT Photonics. However, other PCF and elements having substantially similar characteristics can be used. In an aspect, the femtosecond pulse energy requirement (e.g., 1 μJ in a conventional amplification system) is much lower for the PCF 200 (e.g., 1 nJ), as illustrated in FIG. 3.

As shown in FIG. 3, when coupled into a photonic crystal fiber (e.g., Femtowhite 800), a <1 nJ monochromatic (˜800 nm) femtosecond laser pulse can produce a broadband supercontinuum with the spectrum, as shown. As provided herein, such a supercontinuum can be successfully used as a seed pulse for an OPA.

The lower energy requirement of the PCF 200 provides an OPA that can be powered by a femtosecond oscillator. By using the PCF 200 for the white light generation, it is also possible to use nanosecond pulses as the pump pulse. Since, with a nanosecond laser, it is impossible to generate a white light in bulk crystals, the system 100 provides a unique opportunity. An example of a laser that can be used to generate the pump signal or pump pulse is a conventional microchip laser, such as SNP-13E (Teem Photonics). Such lasers are inexpensive (˜$10,000), have a pulse energy of ˜10 μJ and a pulse duration of ˜1 ns. As a further example, the PCF 200 can be an element similar to that used in the STM light source manufactured by Leukos Systems.

Returning to FIG. 1, the system 100 can further comprise one or more amplification stages 104. In an aspect, the one or more amplification stages 104, 104′ can comprise one or more non-linear crystals 106, 106′. As an example, the seed pulse can be focused on the one or more non-linear crystals 106, 106′ together with the pump pulse to provide parametric amplification of the seed pulse. In an aspect, a second harmonic generation stage 107 can be used to generate a second harmonic beam. As an example, the second harmonic beam can be used as a pump beam for a second amplification stage power amplifier (e.g., OPA 106′).

In an aspect, the system 100 can further comprise one or more lens optics, reflective optics, beam splitters, filters, processors, measurement devices, computing devices, and the like. As an example, lens optics may be any conventional optics for focusing electromagnetic radiation. As a further example, reflective optics may be any conventional reflective optics to direct light beams such as mirrors, for example. In an aspect, reflective optics are disposed in the path of the beams to affect the desired direction of the beams. As an example, one or more delay paths 108 can be formed comprising optics such as reflective optics. It is understood that any number of reflective optics may be used to affect the desired direction of the beams. As a further example, a processor 110 can comprise an optical compressor or other optical processing device to detect characteristics of the resultant beam (e.g., pulse duration, energy level, etc.).

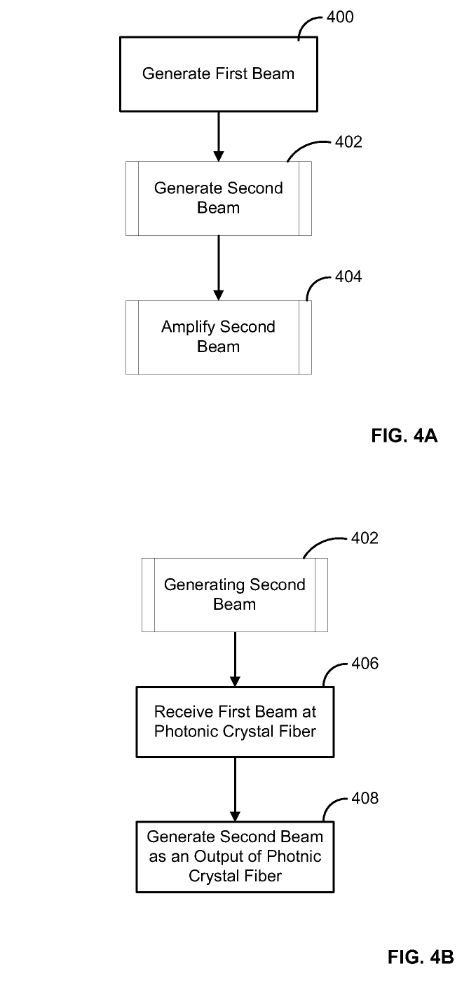

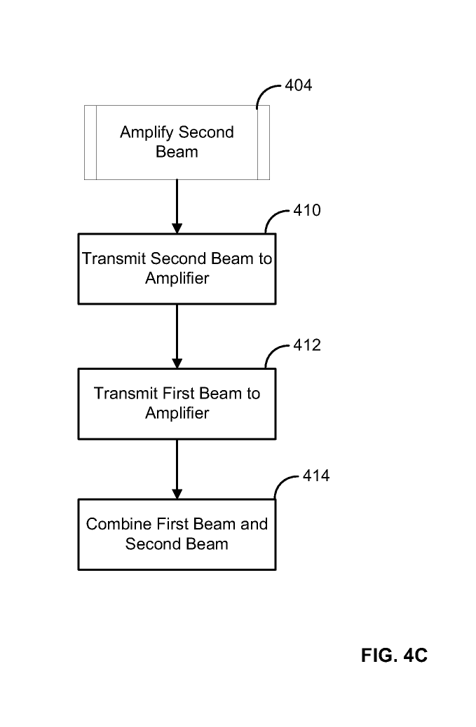

FIG. 4A illustrates an exemplary method that can be carried out by the system 100, for example. In step 400, a first beam of electromagnetic radiation (e.g., pump beam) can be generated. As an example, the first beam can be generated as a pulsed laser having a pre-determined pulse duration and/or output energy. In an aspect, the first beam can have a pulse duration of less than 500 femtoseconds. In an aspect, first beam can have an output energy of between about 1 nanojoule(s) and about 10 nanojoules. In an aspect, the first beam can have a pulse duration of about 1 nanosecond. In an aspect, the first beam can have an output energy of equal to or less than about 1 microjoule(s). Other pulse durations and energy levels can be used. However, due to the use of the PCF 200 for seed generation, the first beam can have pulse duration beyond conventionally acceptable durations and output energies below conventionally acceptable levels.

In step 402, a second beam (e.g., seed beam) can be generated. In an aspect, the second beam is generated by energizing a photonic crystal fiber. As more clearly shown in FIG. 4B, for example, the first beam can be received at the PCF 200 to energize the PCF 200, at step 406. Accordingly, the second beam is generated as an output of the energized PCF 200, at step 408.

Returning to FIG. 4A, in step 404, the second beam can be amplified. In an aspect, the second beam can be amplified using parametric amplification. As more clearly shown in FIG. 4C, for example, the second beam can be transmitted to a non-linear crystal, at step 410. In step 412, the first beam can be transmitted to the non-linear crystal irradiated by the second beam. As an example, the first beam can be transmitted to the non-linear crystal via a delay path (e.g., delay path 108). In step 414, the first beam and the second beam are combined to amplify the second beam and to generate an amplified output beam.

In an aspect, following generation of the second beam (e.g., seed pulse), the first beam and the second beam can be combined in a nonlinear crystal (e.g., a first parametric amplification stage (preamplifier)). As an example, to achieve temporal overlap, the relative timing of the first beam and the second beam can be adjusted by a delay line (e.g., delay path 108). As a further example, a spot size of the first beam in the nonlinear crystal can be set by a telescope and can be chosen to achieve the highest possible gain without causing optical damage of the crystal, or inducing third-order nonlinear effects (self-focusing, self phase modulation, or white light generation) that would cause beam distortion or breakup.

In an aspect, the preamplifier can also used as a spatial filter, to improve the spatial coherence of the signal beam by amplifying only those spatial components of the supercontinuum that overlap with the pump beam in the crystal. After the first amplification stage, the amplified beam can be further amplified in a second stage, power amplifier. As an example, the power amplification stage can be driven into saturation, i.e., with significant pump depletion and conversion efficiency above 30%. After the power amplifier, signal and idler beams can be separated from the pump and from each other using dichroic filters or mirrors. Finally, in case of broadband amplification, a pulse compressor can be used to obtain transform-limited pulse duration.

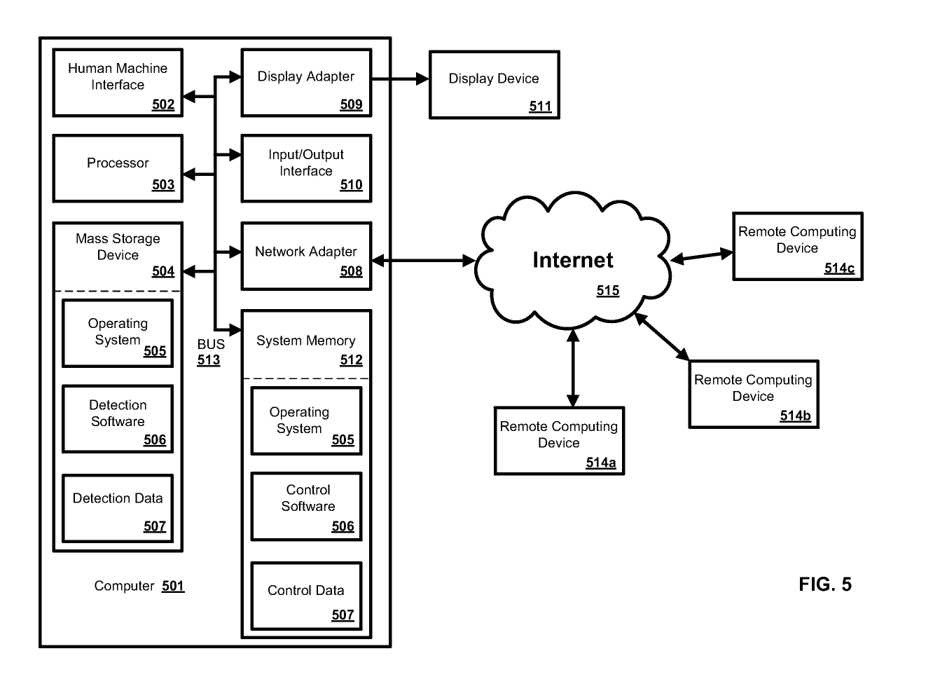

FIG. 5 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 501. As an example, one or more components of the system 100 can be controlled by computer 501. As a further example, the computer 501 can be in communication with elements for measuring characteristics of beams of electromagnetic radiation (e.g., processor 110). The components of the computer 501 can comprise, but are not limited to, one or more processors or processing units 503, a system memory 512, and a system bus 513 that couples various system components including the processor 503 to the system memory 512. In the case of multiple processing units 503, the system can utilize parallel computing.

The system bus 513 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 513, and all buses specified in this description can also be implemented over a wired or wireless network connection and each of the subsystems, including the processor 503, a mass storage device 504, an operating system 505, control software 506, control data 507, a network adapter 508, system memory 512, an Input/Output Interface 510, a display adapter 509, a display device 511, and a human machine interface 502, can be contained within one or more remote computing devices 514a,b,c at physically separate locations, connected through buses of this form, in effect implementing a fully distributed system.

The computer 501 typically comprises a variety of computer readable media.

Exemplary readable media can be any available media that is accessible by the computer 501 and comprises, for example and not meant to be limiting, both volatile and non-volatile media, removable and non-removable media. The system memory 512 comprises computer readable media in the form of volatile memory, such as random access memory (RAM), and/or non-volatile memory, such as read only memory (ROM). The system memory 512 typically contains data such as control data 507 and/or program modules such as operating system 505 and control software 506 that are immediately accessible to and/or are presently operated on by the processing unit 503.

In another aspect, the computer 501 can also comprise other removable/non-removable, volatile/non-volatile computer storage media. By way of example, FIG. 5 illustrates a mass storage device 504 which can provide non-volatile storage of computer code, computer readable instructions, data structures, program modules, and other data for the computer 501. For example and not meant to be limiting, a mass storage device 504 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 504, including by way of example, an operating system 505 and control software 506. Each of the operating system 505 and control software 506 (or some combination thereof) can comprise elements of the programming and the control software 506. Control data 507 can also be stored on the mass storage device 504. Control data 507 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 501 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 503 via a human machine interface 502 that is coupled to the system bus 513, but can be connected by other interface and bus structures, such as a parallel port, game port, an IEEE 1394 Port (also known as a Firewire port), a serial port, or a universal serial bus (USB).

In yet another aspect, a display device 511 can also be connected to the system bus 513 via an interface, such as a display adapter 509. It is contemplated that the computer 501 can have more than one display adapter 509 and the computer 501 can have more than one display device 511. For example, a display device can be a monitor, an LCD (Liquid Crystal Display), or a projector. In addition to the display device 511, other output peripheral devices can comprise components such as speakers (not shown) and a printer (not shown) which can be connected to the computer 501 via Input/Output Interface 510. Any step and/or result of the methods can be output in any form to an output device. Such output can be any form of visual representation, including, but not limited to, textual, graphical, animation, audio, tactile, and the like.

The computer 501 can operate in a networked environment using logical connections to one or more remote computing devices 514a,b,c. By way of example, a remote computing device can be a personal computer, portable computer, a server, a router, a network computer, a peer device or other common network node, and so on. Logical connections between the computer 501 and a remote computing device 514a,b,c can be made via a local area network (LAN) and a general wide area network (WAN). Such network connections can be through a network adapter 508. A network adapter 508 can be implemented in both wired and wireless environments. Such networking environments are conventional and commonplace in offices, enterprise-wide computer networks, intranets, and the Internet 515.

For purposes of illustration, application programs and other executable program components such as the operating system 505 are illustrated herein as discrete blocks, although it is recognized that such programs and components reside at various times in different storage components of the computing device 501, and are executed by the data processor(s) of the computer. An implementation of control software 506 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A system comprising:
a photonic crystal fiber receiving a pump pulse of electromagnetic radiation and generating a seed pulse of electromagnetic radiation; and
a non-linear crystal receiving the seed pulse and the pump pulse and generating an amplified pulse of electromagnetic radiation based on parametric amplification of the seed pulse.

2. The system of claim 1, wherein the pump pulse has a pulse duration of about 1 nanosecond.

3. The system of claim 1, wherein the pump pulse has an output energy of between about 1 microjoule.

4. The system of claim 1, wherein the pump pulse has a pulse duration of less than 500 femtoseconds.

5. The system of claim 1, wherein the pump pulse has an output energy of about 1 nanojoule.

6. A method comprising:
receiving a pump pulse of electromagnetic radiation at a photonic crystal fiber;
generating a seed pulse of electromagnetic radiation as an output of the photonic crystal fiber;
receiving the seed pulse and the pump pulse at a non-linear crystal; and
generating an amplified pulse of electromagnetic radiation based on parametric amplification of the seed pulse.

7. The method of claim 6, wherein the pump pulse has a pulse duration of about 1 nanosecond.

8. The method of claim 6, wherein the pump pulse has an output energy of about 1 microjoule.

9. The method of claim 6, wherein the pump pulse has a pulse duration of less than 500 femtoseconds

10. The method of claim 6, wherein the pump pulse has an output energy of about 1 nanojoule.

11. A method comprising:
energizing a photonic crystal fiber to generate a seed beam of electromagnetic radiation as an output of the photonic crystal fiber;
transmitting the seed beam to a non-linear crystal; and
generating an amplified beam of electromagnetic radiation based on the seed beam.

12. The method of claim 11, wherein the photonic crystal fiber is energized by a pump pulse having a pre-determined pulse duration.

13. The method of claim 12, wherein the pump pulse has a pulse duration of about 1 nanosecond.

14. The method of claim 12, wherein the pump pulse has an output energy of about 1 microjoule.

15. The method of claim 12, wherein the pump pulse has a pulse duration of less than 500 femtoseconds.

16. The method of claim 12, wherein the pump pulse has an output energy of about 1 nanojoule.

17. The method of claim 11, wherein generating an amplified beam comprises combining the seed beam with a second beam of electromagnetic radiation.

18. The method of claim 11, wherein the second beam of electromagnetic radiation is a pump pulse having a pre-determined pulse duration.

19. The method of claim 18, wherein the pump pulse has a pulse duration of about 1 nanosecond.

20. The method of claim 18, wherein the pump pulse has an output energy of about 10 nanojoules with femtosecond pulses and about 1 millijoule with nanosecond pulses.
